(19) United States
(12) Patent Application Publication
(10) Pub. No.: US 2006/0001851 A1
(43) Pub. Date: Jan. 5, 2006

(54) Immersion photolithography system

(76) Inventors: Robert Bruce Grant, Windlesham (GB); Paul Alan Stockman, Hillsborough, NJ (US)

Correspondence Address: THE BOC GROUP, INC., 575 MOUNTAIN AVENUE, MURRAY HILL, NJ, 07974-2064, US

(21) Appl. No.: 10/882,916

(22) Filed: Jul. 1, 2004

(51) Int. Cl. G03B 27/42

(52) U.S. Cl. 355/53; 355/30

(57) ABSTRACT

In immersion photolithography, immersion fluid is located between a wafer and a lens for projecting an image onto the wafer through the immersion fluid. In order to inhibit evaporation from the immersion fluid, a purge fluid saturated with a component of the immersion fluid is conveyed about the immersion fluid.

### FIELD OF THE INVENTION

This invention relates to an immersion photolithography system, and to a method of performing immersion photolithography.

Photolithography is an important process step in semiconductor device fabrication. In photolithography, a circuit design is transferred to a wafer through a pattern imaged onto a photoresist layer deposited on the wafer surface. The wafer then undergoes various etch and deposition processes before a new design is transferred to the wafer surface. This cyclical process continues, building up the multiple layers of the semiconductor device.

The minimum feature that may be printed using photolithography is determined by the resolution limit W, which is defined by the Rayleigh equation as:

$$W = \frac{{k}_{1} λ}{NA} \qquad ( 1 )$$

where k₁ is the resolution factor, λ is the wavelength of the exposing radiation and NA is the numerical aperture. In lithographic processes used in the manufacture of semiconductor devices, it is therefore advantageous to use radiation of very short wavelength in order to improve optical resolution so that very small features in the device may be accurately reproduced. Monochromatic visible light of various wavelengths have been used, and more recently radiation in the deep ultra violet (DUV) range has been used, including radiation at 193 nm as generated using an ArF excimer laser.

The value of NA is determined by the acceptance angle (α) of the lens and the index of refraction (n) of the medium surrounding the lens, and is given by
NA=n sin α (2)

For clean dry air (CDA), the value of n is 1, and so the physical limit to NA for a lithographic technique using CDA as a medium between the lens and the wafer is 1, with the practical limit being currently around 0.9.

Immersion photolithography is a known technique for improving optical resolution by increasing the value of NA. With reference to FIG. 1, in this technique a liquid 10 having a refractive index n>1 is placed between the lower surface of the objective lens 12 of a projection device 14 and the upper surface of a wafer 16 located on a moveable wafer stage 18. The liquid placed between lens 12 and wafer 16 should, ideally, have a low optical absorption at 193 nm, be compatible with the lens material and the photoresist deposited on the wafer surface, and have good uniformity. These criteria are met by ultra-pure, degassed water, which has a refractive index n≈1.44. The increased value of n, in comparison to a technique where the medium between lens and wafer is CDA, increases the value of NA, which in turn decreases the resolution limit W, enabling smaller features to be reproduced.

Whilst ultra-pure water is ideal for the current generation of lens geometries, even higher refractive index liquids will be required for hyper-NA lens geometries. For example, an organic liquid having the required refractive index can replace the ultra-pure water. A more attractive alternative is to add one or more compounds to the water to increase its refractive index. A problem associated with the use of a saturated solution is that, during immersion lithography, there will be evaporation of ultra-pure water at the interface between the lens and the liquid solution and at the interface between the wafer and the liquid solution, leading to the deposition at these interfaces of solute from the solution.

It is an object of the present invention to provide a system which inhibits evaporation from immersion liquid located between the lens and wafer in an immersion photolithography system.

### SUMMARY OF THE INVENTION

In a first aspect, the present invention provides an immersion lithography system comprising a wafer stage, a lens for projecting an image onto a wafer located on the wafer stage, immersion fluid supply means for supplying immersion fluid between the lens and the wafer, and purge fluid conveying means for conveying about the supplied immersion fluid a purge fluid saturated with a component of the immersion fluid.

By conveying about the immersion fluid a purge fluid saturated with a component of the immersion fluid, evaporation from the immersion fluid can be inhibited. This can prevent the deposition during photolithography of particulates at the interfaces between the immersion fluid and the lens, wafer and/or purge fluid. Where the immersion fluid is a pure liquid, such as ultra-pure water, saturating the purge fluid with the liquid can prevent the deposition at these interfaces of particulates formed within the liquid, for example, from the photoresist layer, during photolithography. Where the immersion fluid is a solution, saturating the purge fluid with the solvent can also inhibit the deposition of solute at these interfaces.

The purge fluid may comprise one of clean, dry air (CDA), nitrogen, or any other liquid or gas which does not react adversely with the immersion fluid, an example of which is a water-based solution containing an inorganic or organic solute.

In another aspect of the present invention, the immersion lithography system comprises an enclosure housing the wafer stage and the lens, the purge fluid supply system being configured to supply to the enclosure a stream of purge fluid. This enclosure can assist in maintaining a saturated environment about the immersion fluid, and so in a second aspect the present invention provides an immersion lithography system comprising an enclosure housing a wafer stage and a lens for projecting an image onto a wafer located on the wafer stage, immersion fluid supply means for supplying into the enclosure immersion fluid through which, during use, the lens projects an image onto the wafer, and purge fluid conveying means for conveying through the enclosure a purge fluid saturated with a component of the immersion fluid.

In another aspect of the present invention, a method is provided for performing immersion photolithography comprising the steps of locating an immersion fluid between a wafer and a lens, projecting an image onto the wafer through the immersion fluid, and conveying about the immersion fluid a purge fluid saturated with a component of the immersion fluid.

In yet a further aspect of the present invention, a method is provided for performing immersion photolithography comprising the steps of providing an enclosure housing a lens, positioning within the enclosure a wafer such that the lens projects an image onto the wafer, maintaining within the enclosure an immersion fluid between the lens and the wafer, and conveying through the enclosure a purge fluid saturated with a component of the immersion fluid.

Features described above in relation to system aspects of the invention are equally applicable to method aspects, and vice versa.

### BRIEF DESCRIPTION OF THE DRAWINGS

FIG. 1 illustrates schematically a known immersion photolithography system; and

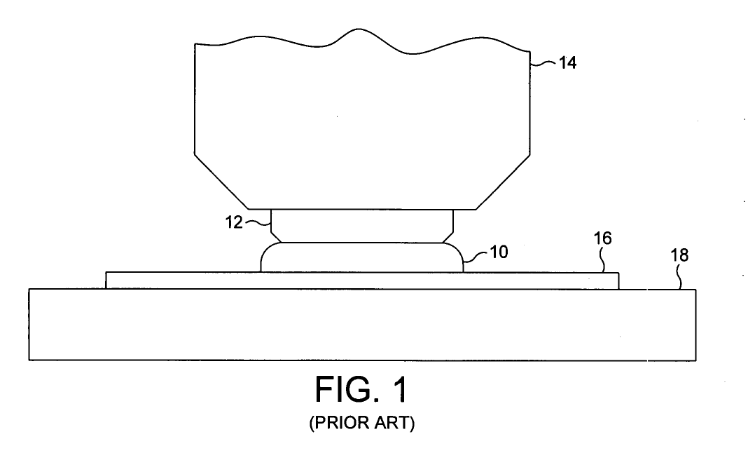

FIG. 2 illustrates schematically the immersion photolithography system in accordance with the present invention.

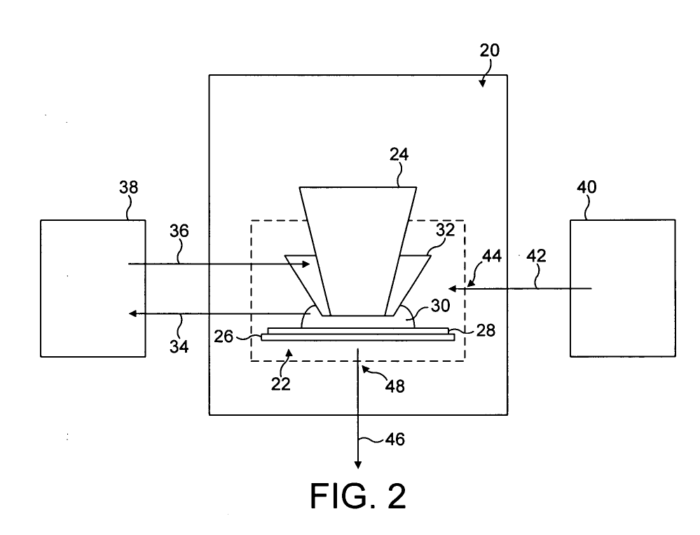

With reference to FIG. 2, an immersion photolithography system 20 comprises an enclosure 22 housing an imaging lens 24 and a wafer stage 26 in a controlled environment. The imaging lens 24 is the final optical component of an optical system for projecting an image onto a photoresist layer formed on the surface of wafer 28 located on the wafer stage 26. The wafer stage 26 may comprises any suitable mechanism for holding the wafer 28 to the wafer stage, for example a vacuum system, and is moveable to position accurately the wafer 28 beneath the imaging lens 24.

Immersion fluid 30 is maintained between the lens 24 and the wafer 28 by an immersion fluid supply system. This system comprises an immersion fluid dispenser 32 surrounding the lens 24 to dispense the immersion fluid 30 locally between the lens 24 and the wafer 28. One or more differential air seals (not shown) may be used to prevent the ingress of immersion fluid into other parts of the system, for example, the mechanism used to move the wafer stage 26.

Due to outgassing from the photoresist layer and the generation of particulates during photolithography, it is desirable to maintain a steady flow of immersion fluid between the lens 24 and the wafer 28. As depicted in FIG. 2, the immersion fluid supply system comprises an evacuation system, shown generally at 34, for drawing the immersion fluid 30 from between the lens 24 and the wafer 28, the dispenser 32 serving to replenish the immersion fluid 30 so that a substantially constant amount of immersion fluid 30 is maintained between the lens 24 and the wafer 28. An immersion fluid supply, shown generally at 36, serves to supply the immersion fluid to the dispenser 32 from a source 38 thereof. Optionally, the immersion fluid drawn from the enclosure 22 may be recycled and recirculated back to the dispenser 32.

An example of a suitable immersion fluid is ultra-pure, degassed water, due to its relatively high refractive index of 1.44 compared to air (having a refractive index of 1) and its compatibility with the lens material and photoresist. In order to increase the refractive index further, inorganic or organic compounds may be added to the water to form a saturated solution. Such a compound may be an organic, polar compound or an inorganic ionic compound. Inorganic salts having relatively large ions can be used such as caesium sulphate. In order to achieve as high a refractive index as possible, the solution of ultra-pure water and inorganic salt should be blended so as to have a high saturation level. In either case, evaporation of water during the photolithographic process can cause deposits to be formed at the interface between the lens 24 and the immersion fluid 30, and at the interface between the wafer 28 and the immersion fluid 30. Where the immersion fluid is a pure liquid, such as ultra-pure water, the sources of these deposits are particulates formed during photolithograpy, whereas where the immersion fluid is a solution, these particulates can additionally comprise micro crystals of the solute.

In order to inhibit the evaporation of the liquid, or solute, from the immersion fluid 30 during photolithography, a purge fluid supply system is provided for supplying to the enclosure 22, and in particular about the immersion fluid 30 within the enclosure 22, a purge fluid saturated with the liquid, or solute as the case may be, of the immersion fluid 30. The purge fluid is conveyed from a source 40 into the enclosure 22 via conduit 42 communicating with an inlet 44 of the enclosure 22. In order to maintain a steady flow of purge fluid within the enclosure 22, a purge fluid evacuation system is provided from drawing the purge fluid from the enclosure 22 via conduit 46 communicating with an outlet 48 of the enclosure 22.

Where the liquid, or solute, is water, for example, the purge fluid may conveniently comprise water-saturated CDA. This can be produced in the source 40 by passing a stream of CDA over one side of a membrane contactor in fluid communication with ultra-pure water on its other side. The water-saturated CDA is then conveyed into the enclosure 22 to purge the interface between the lens 24 and the immersion fluid 30 and the interface between the wafer 28 and the immersion fluid 30 to inhibit the evaporation of water from the immersion fluid 30.

While the foregoing description and drawings represent the preferred embodiments of the present invention, it will be apparent to those skilled in the art that various changes and modifications may be made therein without departing from the true spirit and scope of the present invention.

1. An immersion lithography system comprising a wafer stage; a lens for projecting an image onto a wafer located on the wafer stage; immersion fluid supply means for supplying immersion fluid between the lens and the wafer; and purge fluid conveying means for conveying about the supplied immersion fluid a purge fluid saturated with a component of the immersion fluid.

2. The system according to claim 1 wherein the immersion fluid is a solution comprising a solvent and at least one solute, the purge fluid being saturated with the solvent.

3. The system according to claim 2 wherein the solvent is water.

4. The system according to claim 2 wherein the solute comprises an inorganic or organic compound.

5. The system according to claim 1 wherein the purge fluid comprises a saturated gas.

6. The system according to claim 5 wherein the gas is one of clean, dry air and nitrogen.

7. The system according to claim 1 further comprising an enclosure housing the wafer stage and the lens, the purge fluid supply system being configured to supply to the enclosure a stream of purge fluid.

8. The system according to claim 7 wherein the enclosure has an inlet for receiving the stream of purge fluid, and an outlet for exhausting purge fluid from the enclosure.

9. The system according to claim 1 wherein the immersion fluid supply means is configured to supply the immersion fluid locally between the lens and the wafer.

10. An immersion lithography system comprising: an enclosure housing a wafer stage and a lens for projecting an image onto a wafer located on the wafer stage; immersion fluid supply means for supplying immersion fluid into the enclosure; and purge fluid conveying means for conveying a purge fluid saturated with a component of the immersion fluid through the enclosure.

11. A method of performing immersion photolithography comprising the steps of: locating an immersion fluid between a wafer and a lens; projecting an image onto the wafer through the immersion fluid; and conveying about the immersion fluid a purge fluid saturated with a component of the immersion fluid.

12. The method according to claim 11 wherein the immersion fluid is a solution comprising a solvent and at least one solute, the purge fluid being saturated with the solvent.

13. The method according to claim 12, wherein the solvent is water.

14. The method according to claim 12 wherein the solute comprises an inorganic or organic compound.

15. The method according to claim 11 wherein the purge fluid comprises a saturated gas.

16. The method according to claim 15 wherein the gas is one of clean, dry air and nitrogen.

17. The method according to claim 11 further including the step of providing a stream of purge fluid to the enclosure wherein the wafer stage and lens are housed within an enclosure.

18. The method according to claim 11 wherein the immersion fluid is supplied locally between the len and the wafer.

19. A method of performing immersion photolithography comprising the steps of: providing an enclosure housing a lens; positioning within the enclosure a wafer such that the lens projects an image onto the wafer; maintaining within the enclosure an immersion fluid between the lens and the wafer; and conveying through the enclosure a purge fluid saturated with a component of the immersion fluid.
